(19) United States
(12) Patent Application Publication
(10) Pub. No.: US 2017/0004477 A1
(43) Pub. Date: Jan. 5, 2017

(54) INFORMATION PROCESSING APPARATUS AND METHOD FOR DEDUCTING TAX AMOUNT

(71) Applicant: TOSHIBA TEC KABUSHIKI KAISHA, Tokyo (JP)

(72) Inventor: Yasunobu Suzuki, Sunto (JP)

(21) Appl. No.: 15/187,984

(22) Filed: Jun. 21, 2016

(30) Foreign Application Priority Data
Jun. 30, 2015 (JP) 2015-131906

(51) Int. Cl. G06Q 20/20; G06Q 30/02; G06Q 40/00

(52) U.S. Cl. CPC G06Q 20/207; G06Q 40/10; G06Q 30/0238

(57) ABSTRACT

An information processing apparatus comprises a tax exemption processing module configured to execute a tax exemption processing for exempting payment of tax on a sales item which is exempted from the taxation, a designation module configured to designate a transaction to which the tax exemption processing is not executed, and a tax exemption control module configured to carry out tax-exemption deduction processing for deducting a tax amount from a tax-included total amount of the sales item which is exempted from the taxation in the transaction designated by the designation module.

### CROSS-REFERENCE TO RELATED APPLICATION

This application is based upon and claims the benefit of priority from Japanese Patent Application No. 2015-131906, filed Jun. 30, 2015, the entire contents of which are incorporated herein by reference.

### FIELD

Embodiments described herein relate generally to an information processing apparatus and a method for deducting a tax amount.

### BACKGROUND

Conventionally, in a case in which a business person who runs an export commodity store (duty-free store) sells a sales item such as a commodity to a nonresident such as a foreign tourist, there is a so-called tax exemption system in which taxes such as a consumption tax and the like levied on the sales item is exempted.

The procedures by the nonresident at the time of applying such a tax exemption system include indicating of a passport, recording of necessary items in a document and the like, which are troublesome.

Incidentally, up to now, a document form is regulated in the decree; however, the document with the document form is optional as long as items regulated by the decree are recorded thereon. If the document is attached with a copy of a voucher (detailed statement on which all or part of items supposed to be stated are recorded) which is delivered to a customer and an official seal (tally impression) is affixed at the joining part of the voucher and the document, the items stated in the voucher can be omitted in the statement of the document.

However, if a sales processing is carried out on a sales item purchased by the nonresident in a tax-included manner and a tax exemption processing is subsequently executed on the transaction (same sales item), a new transaction is executed after the sales processing which is completed is once canceled, and the tax exemption processing is executed at the time of executing the new transaction.

### DESCRIPTION OF THE DRAWINGS

FIG. 1 is a schematic constitution diagram of a POS system according to an embodiment;

FIG. 2 is a block diagram illustrating the hardware structure of a server;

FIG. 3 is a diagram illustrating an example of the data structure of a commodity master file;

FIG. 4 is a diagram illustrating an example of the data structure of a tax exemption division file;

FIG. 5 is a diagram illustrating an example of the data structure of a tax exemption set value file;

FIG. 6 is a diagram illustrating an example of the data structure of a transaction history;

FIG. 7 is a block diagram illustrating the hardware structure of a POS terminal;

FIG. 8 is a functional block diagram illustrating functional components of the POS terminal;

FIG. 9 is a flowchart illustrating flow of a control processing executed by the POS terminal;

FIG. 10 is a flowchart illustrating flow of a general tax exemption processing;

FIG. 11 is a diagram illustrating an example of a confirmation screen;

FIG. 12 is a diagram illustrating an example of a commodity registration screen;

FIG. 13 is a diagram illustrating an example of an error screen;

FIG. 14 is a diagram illustrating an example of a commodity registration screen;

FIG. 15 is a diagram illustrating an example of a purchase written oath;

FIG. 16 is a diagram illustrating an example of a purchase record slip;

FIG. 17 is a diagram illustrating an example of a receipt;

FIG. 18 is a flowchart illustrating flow of a tax exemption recount processing;

FIG. 19 is a flowchart illustrating flow of the tax exemption recount processing;

FIG. 20 is a diagram illustrating an example of a tax exemption recount screen;

FIG. 21 is a diagram illustrating an example of the tax exemption recount screen;

FIG. 22 is a diagram illustrating an example of the tax exemption recount screen;

FIG. 23 is a diagram illustrating an example of a refund receipt;

FIG. 24 is a flowchart illustrating flow of a tax exemption recount cancellation processing;

FIG. 25 is a diagram illustrating an example of a tax exemption recount cancellation screen;

FIG. 26 is a diagram illustrating an example of the tax exemption recount cancellation screen; and

FIG. 27 is a diagram illustrating an example of a tax exemption recount cancellation receipt.

### DETAILED DESCRIPTION

In accordance with an embodiment, an information processing apparatus includes a tax exemption processing module configured to execute a tax exemption processing for exempting payment of tax on a sales item which is exempted from the taxation, a designation module configured to designate a transaction to which the tax exemption processing is not executed, and a tax exemption control module configured to carryout tax-exemption deduction processing for deducting a tax amount from a tax-included total amount of the sales item which is exempted from the taxation in the transaction designated by the designation module.

In the embodiment, a POS (Point Of Sales) system used in an export commodity store (duty-free store) at which a sales item used in an ordinary or a common life is sold to a nonresident such as a foreign tourist with a certain method is described. The embodiment exemplifies that an invention is applied to a POS terminal arranged in a duty-free store as an information processing apparatus. In the embodiment, a commodity is described as a sales item. In the following description, a tax exemption recount refers to execution of a tax exemption processing based on information of the transaction subsequently on a past transaction in which a commodity is sold to a customer in a tax-included manner.

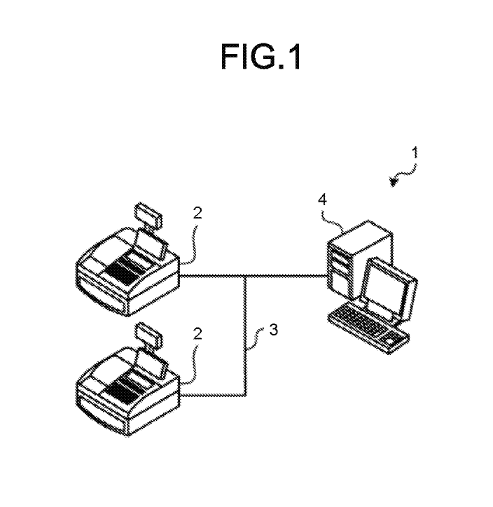

FIG. 1 is a schematic constitution diagram of a POS system 1 according to the embodiment. The POS system 1 includes, as shown in FIG. 1, a plurality of POS terminals 2 (2, in the figure) and a server 4 serving as an information processing apparatus for collectively managing these POS terminals 2 connected therewith through a network 3 such a LAN (Local Area Network).

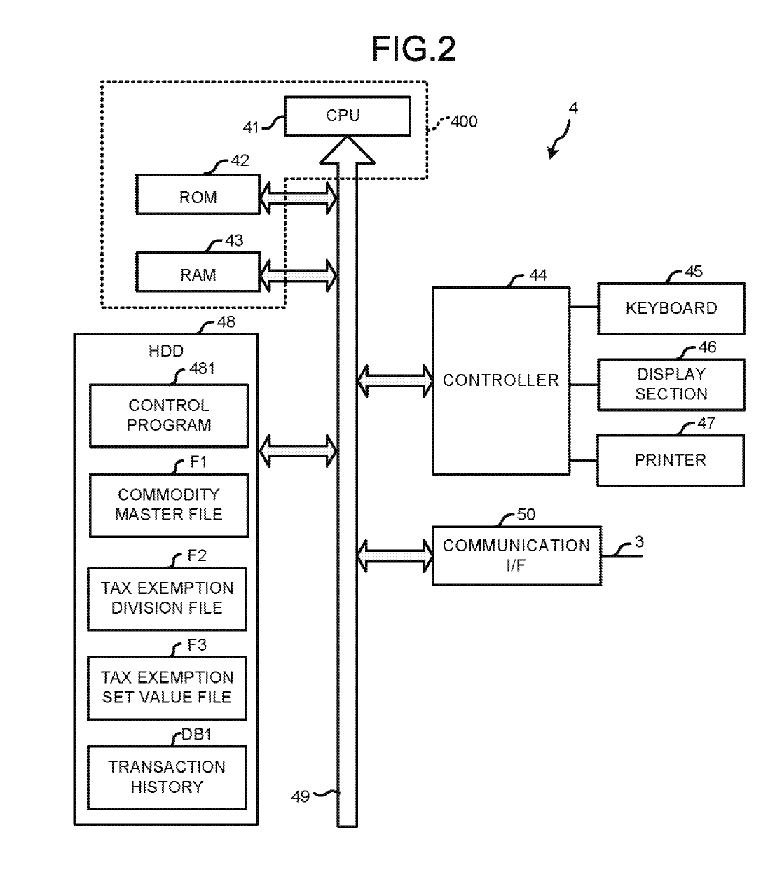

The server 4 controls the whole of the POS system 1. FIG. 2 is a block diagram illustrating the hardware structure of the server 4. The server 4 is equipped with a control section 400 having a computer structure constituted by a CPU (Central Processing Unit) 41, a ROM (Read Only Memory) 42, and a RAM (Random Access Memory) 43.

The control section 400 is connected with a communication I/F (interface) 43 via a bus line 49. The server 4 performs an online communication with a plurality of POS terminals 2 via a communication I/F 50 and the network 3 (refer to FIG. 1). A keyboard 45, a display section 46 and a printer 47 are connected with the control section 400 via the bus line 49 and a controller 44. An HDD (Hard Disk Drive) 48 is connected with the control section 400 via the bus line 49. The HDD 48 stores various control programs 481 for enabling the control section 400 to operate. The HDD 48 also stores a commodity master file F1, a tax exemption division file F2 and a tax exemption set value file F3. Further, the HDD 48 stores a transaction history DB1 as a database for accumulating information relating to a transaction to which a sales registration processing is executed by the POS terminal 2.

The control program 481 executed by the server 4 according to the embodiment is a file of an installable form or an executable form and may be recorded in a computer-readable recording medium to be supplied. The recording medium is a CD-ROM, an FD (Flexible Disk), a CD-R, a DVD (Digital Versatile Disk) and the like.

Further, the control program 481 executed by the server 4 according to the embodiment is stored in a computer connected with a network such as an internet and may be supplied through being downloaded via a network. The control program 481 executed by the server 4 according to the embodiment may be supplied or distributed via the network such as the internet.

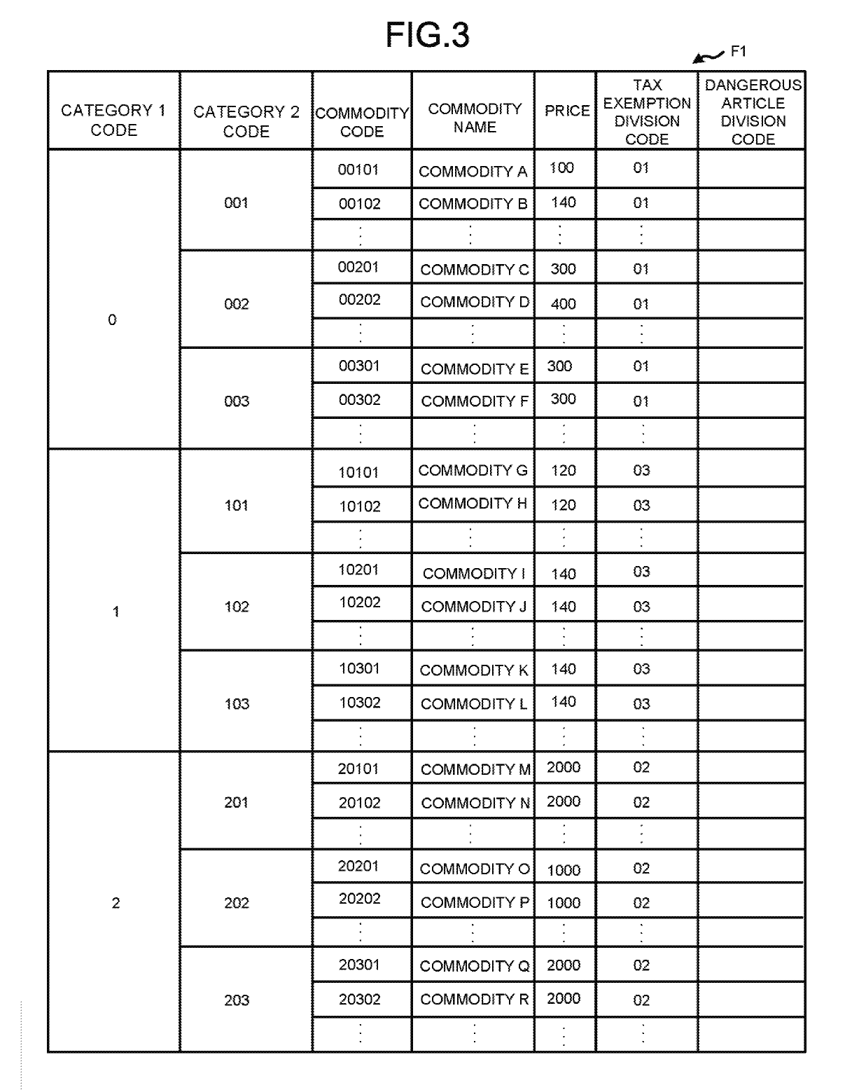

Next, the commodity master file F1 and a commodity category (classification) set in the commodity master file F1 are described. FIG. 3 is a diagram illustrating an example of the data structure of the commodity master file F1. As shown in FIG. 3, in the commodity master file F1, commodity information such as a commodity name and a commodity price (unit price), category codes (category 1 code and category 2 code), a tax exemption division code and a dangerous article division code is set in association with a commodity code (commodity identification information) of each commodity (sales registration item). The dangerous article division code is applied to a commodity such as a spray (flammable substance is included) and the like, required to handle with care, which is prohibited from being taken into the airplane.

Commodities are classified according to a plurality of category codes and those plural categories are hierarchically constructed.

As shown in FIG. 3, commodities are classified into a plurality of categories according to a category 1 (high-order classification) which is a rough classification. Further, each category 1 is classified in detail according to a category 2 (lower-order classification) which is more detailed classification. The high-order classification 1 is classified into a plurality of categories according to the category 2 the order of which is lower than the category 1 and includes at least one lower-order category 2.

From the point of view of the hierarchical construction of the category, the commodity code attached to each commodity can be regarded as a category the order of which is lower than the category 2. The commodity code can be regarded as the most detailed classification, in other words, the lowest-order classification.

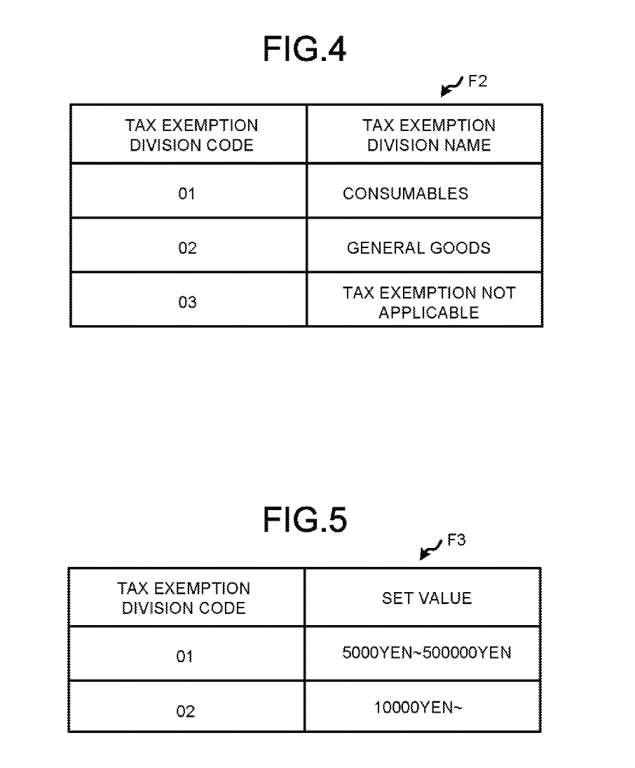

Next, the tax exemption division file F2 is described. FIG. 4 is a diagram illustrating an example of the data structure of the tax exemption division file F2. As shown in FIG. 4, in the tax exemption division file F2, tax exemption division names are set in association with the tax exemption division codes, respectively. The tax exemption division names refer to “consumables”, “general goods” and “tax exemption not applicable”. The “consumables” serving as tax exemption items of which the taxes levied on commodities purchased by a nonresident such as a foreign tourist are exempted, refer to foodstuffs, cosmetics, beverage, chemicals and other commodities. The “general goods”, which are also tax exemption items, refer to commodities used in the ordinary life other than the consumables. The “tax exemption not applicable” refers to a non-tax exemption item to which the tax exemption is not applicable. The tax exemption division code of the “consumables” is “01”. The tax exemption division code of the “general goods” is “02”. The tax exemption division code of the “tax exemption not applicable” is “03”.

Next, the tax exemption set value file F3 is described. FIG. 5 is a diagram illustrating an example of the data structure of the tax exemption set value file F3. As shown in FIG. 5, a set value is defined in the tax exemption set value file F3 in association with the tax exemption division code. The set value is a criterion for executing sales registration as a tax exemption item in each division. In the example shown in FIG. 5, the set value for consumables of which the tax exemption division code is “01” is 5,000 Yen˜500,000 Yen. Further, the set value for general goods (commodities used in the ordinary life other than the consumables) of which the tax exemption division code is “02” is an amount above 10,000 Yen.

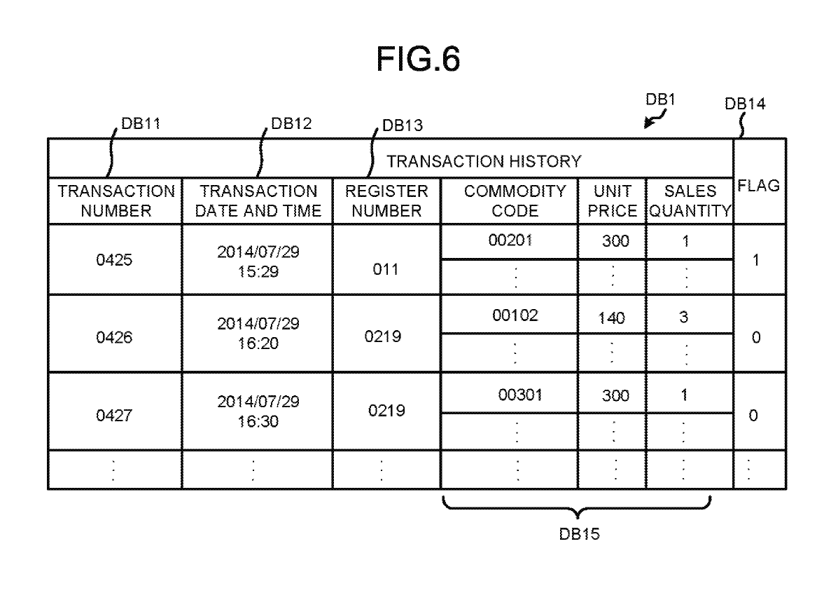

Next, the transaction history DB1 is described. FIG. 6 is a diagram illustrating an example of the data structure of the transaction history DB1. As shown in FIG. 6, transaction information of transactions processed by each POS terminal 2 is stored in the transaction history DB1 as a transaction history. The transaction history includes a transaction number (stored in a transaction number section DB11) for identifying each transaction, a transaction date and time (stored in a transaction date and time section DB12) at which the transaction is executed and a register number (stored in a register number section DB13) used to identify a POS terminal 2 that executes the transaction. The transaction history further includes a commodity code, a unit price, a sales quantity (stored in a commodity information section DB15) of each commodity to which a sales registration is executed. A flag (stored in a flag section DB14) is set in the transaction history DB1 in association with the transaction number. Based on the flag stored in the flag section DB14, a determination is made that whether or not a tax exemption processing described later is executed on the transaction. In the example shown in FIG. 6, the flag “0” represents a transaction to which the tax exemption processing is not executed, and the flag “1” represents a transaction to which the tax exemption processing is executed. In a case of the example in FIG. 6, the tax exemption processing is executed on a transaction of which the transaction number is “0425”, and the tax exemption processing is not executed on a transaction of which the transaction number is “0426” and a transaction of which the transaction number is “0427”. Further, the transaction history DB1 acts a function of an electronic journal which stores a transaction history data.

The control section 400 of the server 4 according to the embodiment delivers the commodity master file F1, the tax exemption division file F2 and the tax exemption set value file F3 to the POS terminal 2 at a prescribed timing through the execution of the control program 481.

Next, the POS terminal 2 is described. The POS terminal 2 is assigned with a unique register number and is arranged at a checkout place. The POS terminal 2 is used to carry out a transaction processing based on a commodity code input by an operator (cashier).

The POS terminal 2 executes a transaction processing relating to sales of a commodity sold in the store. The operator operates the POS terminal 2 to execute a sales registration processing and a settlement processing on a commodity purchased by a customer. The sales registration processing includes a processing of optically reading a code such as a barcode attached to a sold commodity to input the commodity code, a processing of displaying the commodity name and the price (commodity information) of the commodity that are read based on the input commodity code and a processing of storing the commodity information in a buffer. The settlement processing includes a processing of displaying a total amount relating to the transaction based on the commodity information stored in the buffer along with the sales registration processing and displaying the change calculated based on the money (cash) deposited from the customer, a processing of instructing a change dispensing machine to dispense the change and a processing of issuing a receipt on which the commodity information and the settlement information (total amount, deposit amount, change amount, etc.) are printed. Further, a processing which combines the sales registration processing with the settlement processing is referred to as a transaction processing.

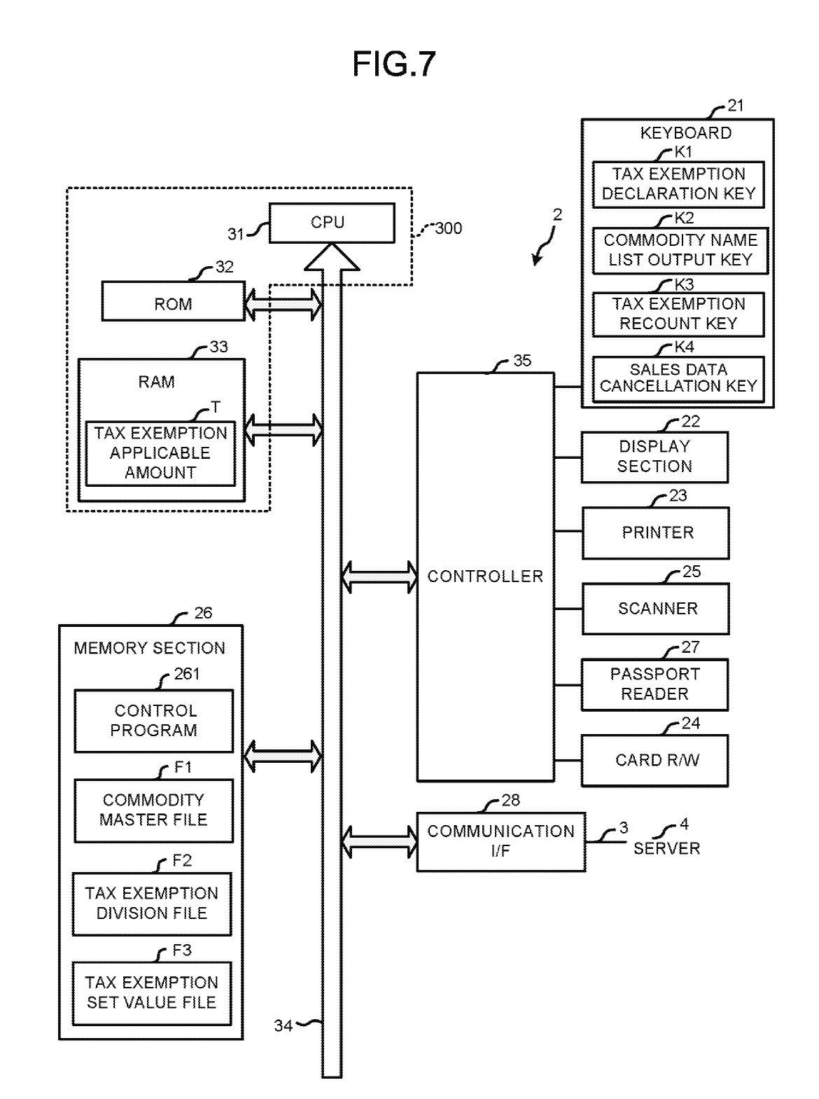

FIG. 7 is a block diagram illustrating the hardware structure of the POS terminal 2. As shown in FIG. 7, the POS terminal 2 is provided with a control section 300 having a computer structure composed of a CPU 31, a ROM 32 and a RAM 33. The CPU 31 executes a various arithmetic processing to control each section of the POS terminal 2. The ROM 32 stores a fixed data. The RAM 33 stores a changeable data in a rewritable manner and is used as a working area. The CPU 31, the ROM 32 and the RAM 33 are connected with each other via a bus line 34.

In the RAM 33, a tax exemption applicable amount table T for totalizing a tax exemption applicable amount described later is formed.

The POS terminal 2 is connected, through a controller 35, with a keyboard 21, a display section 22 composed of a liquid crystal display device on a display surface of which a touch panel is arranged, a printer 23, a card reader/writer (R/W) 24, a scanner 25 for optically reading a code such as a barcode or a two-dimensional code attached to a commodity and a passport reader 27.

Various keys are arranged in each block on the keyboard 21. Various keys include, for example, numeric keys for inputting a commodity code and an amount, a subtotal key for declaring the calculation of the sales total amount, a cash total key for declaring settlement with cash in the sales processing, a PLU key for designating various commodities, a confirmation key for confirming a numerical input with the numeric keys, a clear key and the like. Further, the keyboard 21 includes a tax exemption declaration key K1, a commodity name list output key K2, a tax exemption recount key K3 and a sales data cancellation (so-called “regi-minus”) key K4. The tax exemption declaration key K1 is an operator used to declare the execution of the tax exemption processing on the transaction. The commodity name list output key K2 is an operator used to instruct the input of a list (commodity name list) of commodities (tax exemption applicable items). The tax exemption recount key K3 is an operator used to declare the tax exemption recount to execute the tax exemption processing on a past transaction. The sales data cancellation key K4 is an operator used to declare the cancellation of the transaction.

The passport reader 27 is a device for reading information retained on the passport. In the embodiment, the passport reader 27 has an OCR (Optical Character Recognition) function for optically reading character strings recorded on the passport.

The keyboard 21, the display section 22, the printer 23, the card reader/writer 24, the scanner 25 and the passport reader 27 described above are connected with the control section 300 through the bus line 34 and the controller 35. A storage device serving as a memory section 26 is connected with the control section 300 through the bus line 34. The memory section 26 (HDD (Hard Disc Drive) or a flash memory) maintains stored contents even if the power supply is shut off. The keyboard 21, the display section 22, the printer 23, the card reader/writer 24, the scanner 25, the memory section 26 and the passport reader 27 are controlled by the control section 300.

Further, the POS terminal 2 is equipped with a communication interface (I/F) 28 for executing a data communication with the server 4 serving as a host device through a network 3 arranged in the store. The communication interface 28 is also connected with the bus line 34.

Incidentally, the memory section 26 included in the POS terminal 2 stores an operating system, a control program 261 such as various computer programs and various data files. The data file includes the commodity master file F1, the tax exemption division file F2 and the tax exemption set value file F3 delivered from the server 4.

The control program 261 executed by the POS terminal 2 of the embodiment is recorded in a computer-readable recording medium such as a CD-ROM, an FD (flexible disk), a CD-R or a DVD (Digital Versatile Disk) in the form of an installable or executable file to be supplied.

Further, the control program 261 executed by the POS terminal 2 of the embodiment is stored in a computer connected with the network such as the internet and may be supplied through being downloaded via the network. The control program 261 executed by the POS terminal 2 of the embodiment may be supplied or distributed through the network such as the internet.

The control program 261 executed by the POS terminal 2 of the embodiment may be incorporated in the ROM in advance to be supplied.

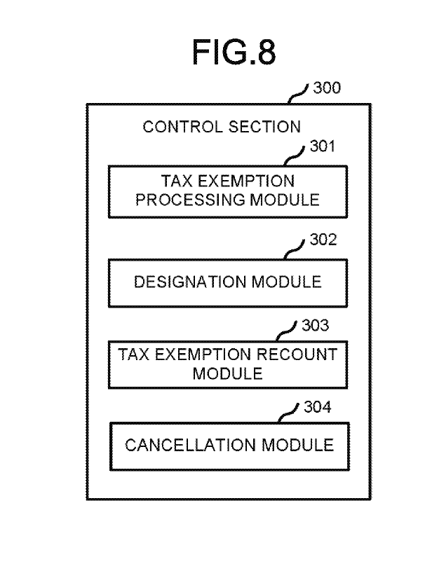

Next, with reference to FIG. 8-FIG. 27, a control processing executed according to the control program 261 by the control section 300 of the POS terminal 2 according to the embodiment is described.

FIG. 8 is a functional block diagram illustrating functional components of the POS terminal 2. The control section 300 realizes functions of a tax exemption processing module 301, a designation module 302, a tax exemption control module 303, a voucher issuing module 304 and a cancellation module 305 according to various programs including the control program 261 stored in the ROM 32 and the memory section 26.

The tax exemption processing module 301 has a function of executing the tax exemption processing for exempting the payment of the tax amount on the commodity, i.e., tax exemption item.

The designation module 302 has a function of designating a transaction to which the tax exemption processing is not executed.

The tax exemption control module 303 has a function of executing a tax-exemption deduction processing for deducting a tax amount (deductible amount) from the tax-included total amount of the commodity, i.e., tax exemption item, on the transaction designated by the designation module 302.

The voucher issuing module 304 has a function of printing a voucher containing information of the commodity to which the tax-exemption deduction processing is executed by the tax exemption control module 303 to issue it.

The cancellation module 305 has a function of cancelling the tax-exemption deduction processing executed by the tax exemption control module 303.

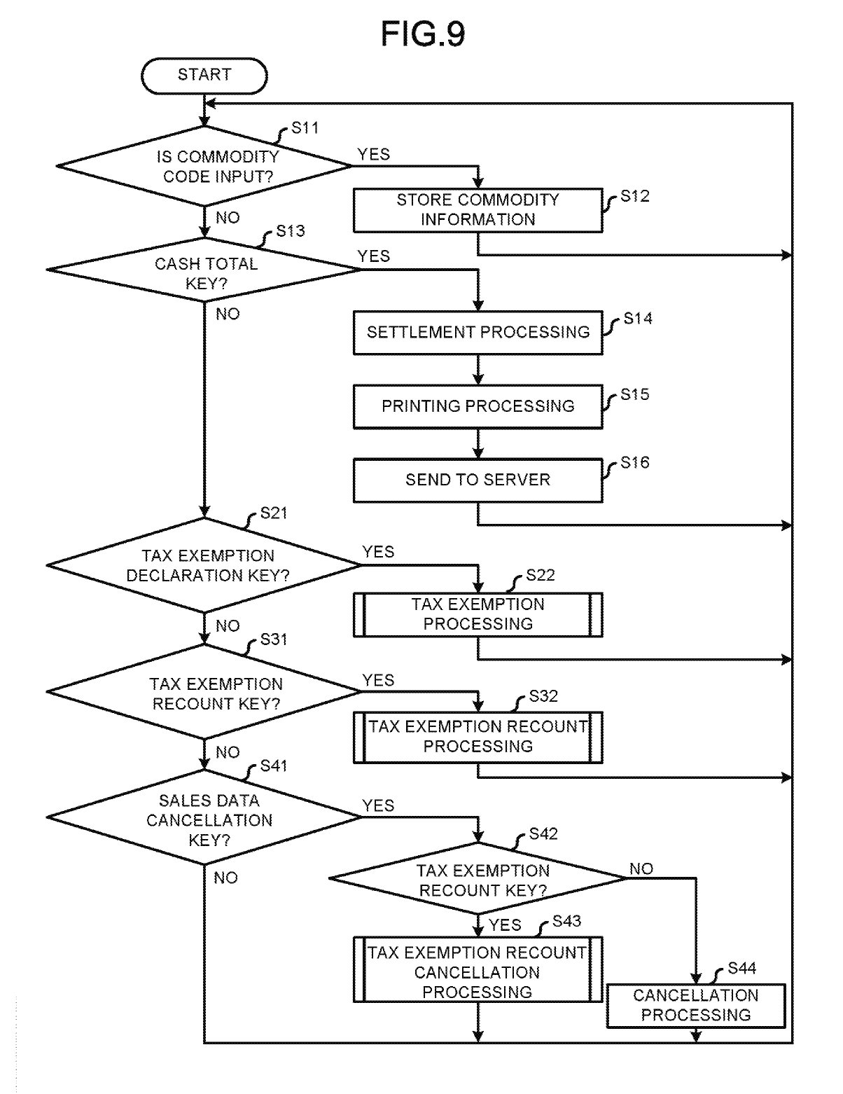

Hereinafter, a control processing executed by the control section 300 of the POS terminal 2 is described with reference to FIG. 9-FIG. 27. FIG. 9 is a flowchart illustrating the flow of the control processing executed by the POS terminal 2. In FIG. 9, the control section 300 determines whether or not a commodity code for specifying the commodity is input with the scanner 25 (ACT S11). If it is determined that the commodity code is input (Yes in ACT S11), the control section 300 executes a sales registration processing for calculating a registration amount of the commodity based on the commodity information such as a commodity name and a unit price obtained by retrieving the commodity master file F1 according to the input commodity code. The control section 300 stores the commodity information of the commodity to which the sales registration processing is executed in the RAM 33 (ACT S12).

If it is determined that the commodity code is not input (No in ACT S11), the control section 300 determines whether or not the cash total key arranged on the keyboard 21 for declaring the termination of the transaction is operated (ACT S13). If it is determined that the cash total key is operated (Yes in ACT S13), the control section 300 executes a settlement processing for calculating the total amount based on the registration amount and the commodity information of the commodity on the transaction (ACT S14). The settlement processing executed in ACT S14 calculates the total amount including an amount of tax such as the consumption tax and the like applied to the commodity purchased by the customer.

The control section 300 prints the commodity information and the settlement information of the commodity to which the settlement processing is executed on a receipt paper to issue a receipt (ACT S15). The transaction number for specifying the transaction is printed on the issued receipt in the form of a barcode. The control section 300 sends the commodity information (the transaction number, the transaction date and time, the register number, the commodity code, the unit price, the sales quantity, etc.) of the commodity to which the transaction processing is executed to the server 4 (ACT S16). The server 4 stores the received information in the transaction history DB1. Specifically, the control section 400 of the server 4 stores the transaction number in the transaction number section DB11. The control section 400 stores the transaction date and time in the transaction date and time section DB12. The control section 400 stores the register number of the POS terminal 2 that executes the transaction processing in the register number section DB13, and stores the commodity code, the unit price and the sales quantity of the transacted commodity in the commodity information section DB15. The control section 400 stores the flag “0” indicating that the tax exemption processing is not executed for the transaction in the flag section DB14 in association with the transaction number of the transaction.

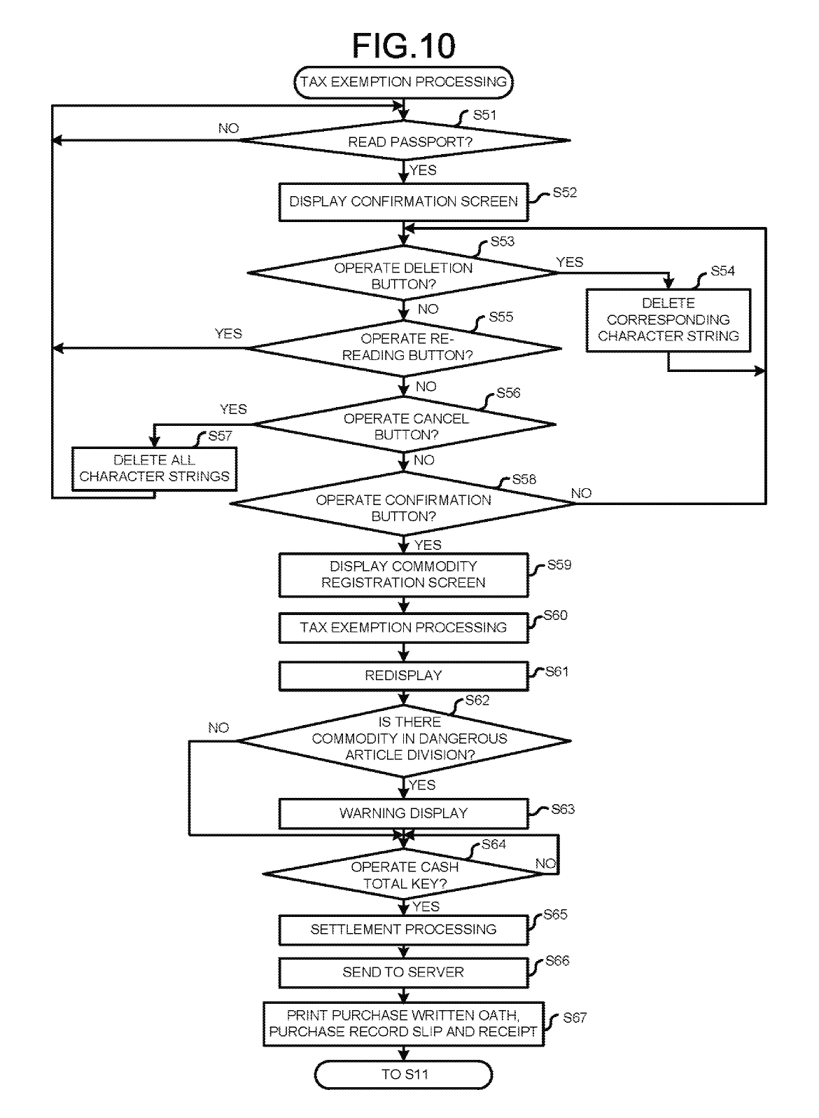

If it is determined that the cash total key is not operated (No in ACT S13), the control section 300 determines whether or not the tax exemption declaration key K1 is operated (ACT S21). If it is determined that the tax exemption declaration key K1 is operated (Yes in ACT S21), it is regarded that the tax exemption processing is declared, and the control section 300 executes the tax exemption processing shown in FIG. 10 (ACT S22).

[General Tax Exemption Processing]

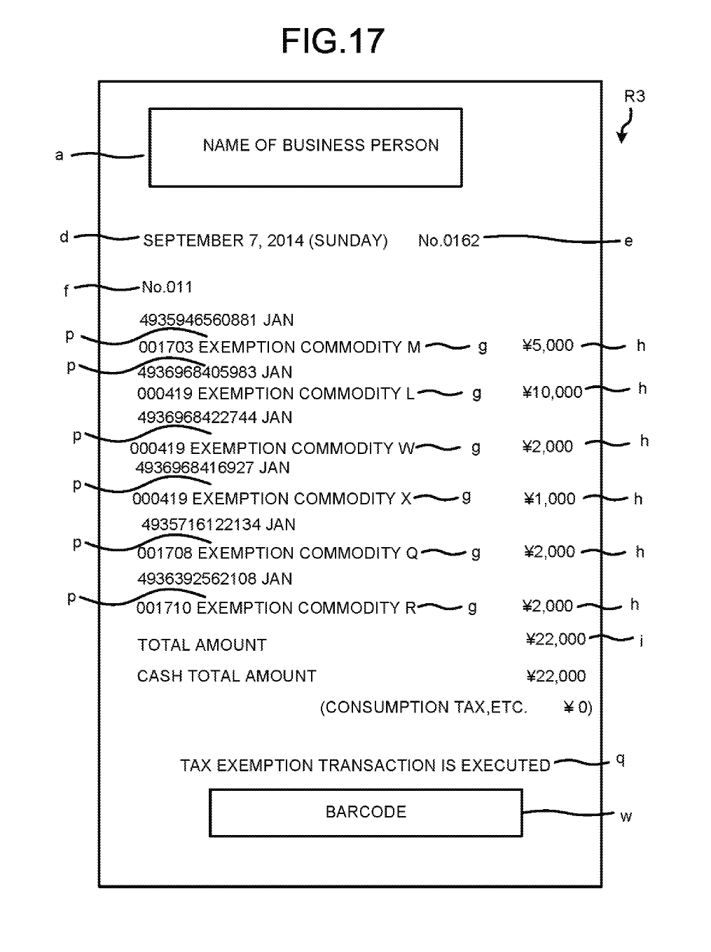

With reference to FIG. 10˜FIG. 17, a general tax exemption processing executed in ACT S22 at the time the tax exemption declaration key K1 is operated is described. In FIG. 10, the control section 300 enables the passport reader 27 to operate. The control section 300 determines whether or not the passport reader 27 reads prescribed character strings from the passport (ACT S51). As the character strings, for example, a passport number, a full name, nationality, a date of birth and the like are exemplified. The control section 300 displays a message “in the process of reading the passport” on the display section 22 until the prescribed character strings are read from the passport.

The control section 300 displays a guidance screen (not shown) for instructing the reading of the passport on the display section 22. The operator of the POS terminal 2 opens a page on which the items relating to the tax exemption system is described in the passport presented from the customer (nonresident) and holds the page over the passport reader 27. In response to the operation, the control section 300 reads the prescribed character strings from the passport.

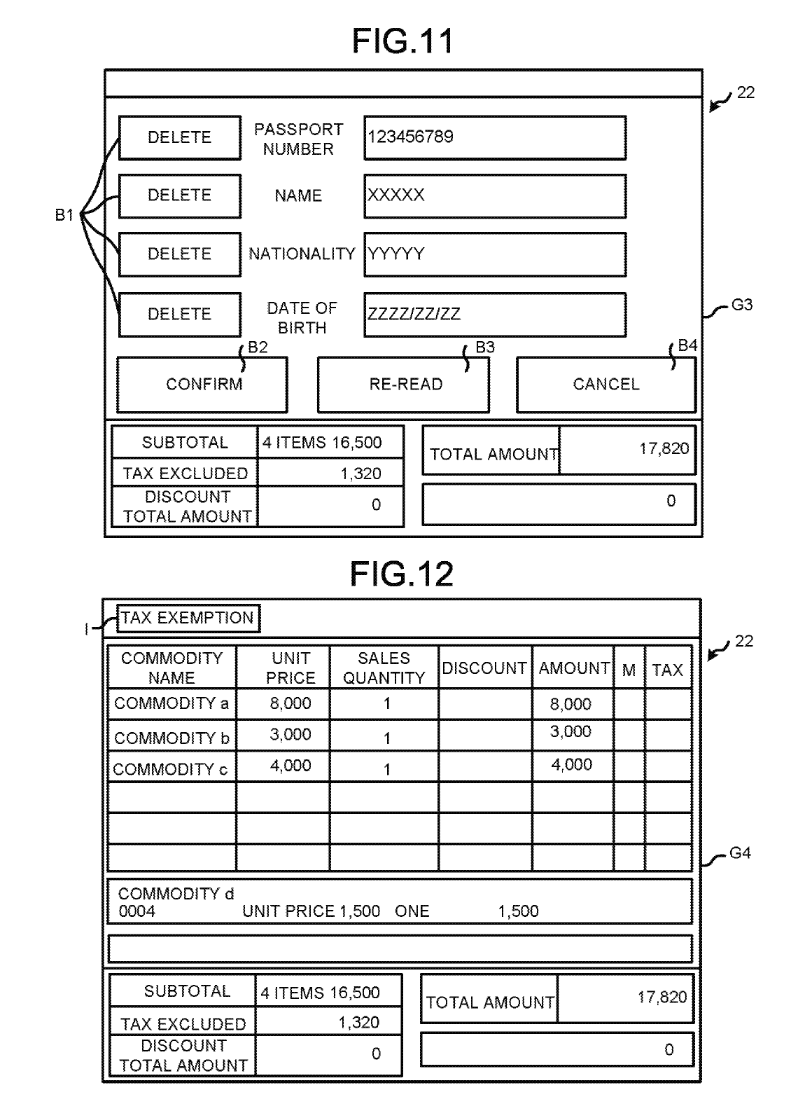

The control section 300 keeps the standby state until the passport is read (No in ACT S51), and if it is determined that the passport is read (Yes in ACT S51), the control section 300 displays a confirmation screen G3 (FIG. 11) on the display section 22 to confirm the character strings read in ACT S51 (ACT S52).

As shown in FIG. 11, the character strings read in ACT S51 are displayed for each item on the confirmation screen G3. In the FIG. 11, a case of reading character strings of items of the passport number, the full name, the nationality and the date of birth among the items printed on the passport is exemplified.

A deletion button B1 is arranged corresponding to each item on the confirmation screen G3. The control section 300 determines the execution of the operation of the deletion button B1 (ACT S53). If it is determined that the deletion button B1 is operated (Yes in ACT S53), the control section 300 deletes the character strings read corresponding to the items (ACT S54), and returns to the processing in ACT S53. For example, if any one of the character strings of items read in ACT S51 is incorrect, the incorrect character string can be deleted through operating the deletion button B1. Further, the control section 300 displays a confirmation screen G3 on which the character string of the item deleted in ACT S54 is blank.

The control section 300 displays a confirmation button B2, a re-reading button B3 and a cancel button B4 corresponding to a confirmation reception module of the embodiment on the confirmation screen G3. The confirmation button B2 is operated if something is confirmed. If it is determined that the deletion button B1 is not operated (No in ACT S53), the control section 300 determines whether or not the re-reading button B3 is operated (ACT S55). If it is determined that the re-reading button B3 is operated (Yes in ACT S55), the control section 300 returns to the processing in ACT S51 to read the character string from the passport again. The character string read last time is deleted in response to the operation of the re-reading button B3.

If it is determined that the re-reading button B3 is not operated (No in ACT S55), the control section 300 determines whether or not the cancel button B4 is operated (ACT S56). If it is determined that the cancel button B4 is operated (Yes in ACT S56), the control section 300 deletes all the read character strings (ACT S57) and returns to the processing in ACT S51. Along with the operation of the cancel button B4, the control section 300 switches the display screen of the display section 22 from the confirmation screen G3 to the commodity registration screen (not shown).

If it is determined that the cancel button is not operated (No in ACT S56), the control section 300 determines whether or not the confirmation button B2 is operated (ACT S58). If it is determined that the confirmation button B2 is operated (Yes in ACT S58), the control section 300 displays a commodity registration screen G4 (ACT S59). The read character string is displayed on the commodity registration screen G4. Next, the control section 300 (tax exemption processing module 301) executes the tax exemption processing for exempting the payment of the amount of the tax such as the consumption tax (ACT S60). If it is determined that the confirmation button B2 is not operated (No in ACT S58), the control section 300 returns to the processing in ACT S53.

FIG. 12 shows an example of the commodity registration screen G4. In FIG. 12, a tax exemption indicator I indicating “tax exemption” is displayed on the commodity registration screen G4. The control section 300 displays the tax exemption indicator I on the commodity registration screen G4 to notify the operator that it is the transaction under the tax exemption declaration.

The tax exemption processing in ACT S60 is described.

First, for the registered commodity of which the registration is already completed, the control section 300 refers to the tax exemption division code in the commodity master file F1 to determine the presence of the tax exemption target commodity, i.e., tax exemption item. If there is a tax exemption target commodity, the control section 300 executes processing for adding the tax exemption applicable amount of each registered commodity, i.e., tax exemption target, group (general goods group·consumables group) to the tax exemption applicable amount table T.

The treatment of the tax exemption target commodities based on the tax categories is executed as follows.

If the registered commodity (tax exemption target) has a tax-included price, the control section 300 adds a tax-excluded amount of the registration amount to the tax exemption applicable amount table T as the tax exemption applicable amount. More specifically, the control section 300 sets the difference between the registration amount before the tax exemption is executed and the registration amount after the tax exemption is executed as the tax exemption amount in a case of a tax-included price. For example, 1,080 Yen (unit price before the tax exemption is applied)−1,000 Yen (unit price after the tax exemption is applied)→80 Yen (tax exemption amount).

If the registered commodity (the tax exemption target) has a tax-excluded price, the control section 300 adds the registration amount as the tax exemption applicable amount to the tax exemption applicable amount table T. More specifically, the control section 300 sets the tax-excluded amount with respect to the registration amount as the tax exemption amount in a case of a tax-excluded price.

In a case in which the registered commodity is not a tax exemption target, the control section 300 does not add the registration amount to the tax exemption applicable amount table T as the tax exemption applicable amount.

Next, the control section 300 determines whether or not the tax exemption applicable amount in the tax exemption applicable amount table T meets the set value (reference amount) in the tax exemption set value file F3. In the tax exemption set value file F3 of the embodiment, as described above, the set value of foodstuff, cosmetics, beverage, chemicals and other consumables is 5,000 Yen-500,000 Yen and the set value of general goods (commodities used in the ordinary life other than the consumables) is greater than 10,000 Yen.

If it is determined that the tax exemption applicable amount of the consumables meets the set value (5,000 Yen˜500,000 Yen), the control section 300 executes the tax exemption processing for exempting the tax amount applied to the tax exemption applicable amount. Similarly, if it is determined that the tax exemption applicable amount of the general goods (commodities used in the ordinary life other than the consumables) meets the set value (amount greater than 10,000 Yen), the control section 300 executes the tax exemption processing for exempting the tax amount applied to the tax exemption applicable amount.

If the tax exemption applicable amount of the consumables in the tax exemption applicable amount table T is greater than the upper limit value (500,000 Yen) of the set value, the control section 300 performs an error display on the display section 22.

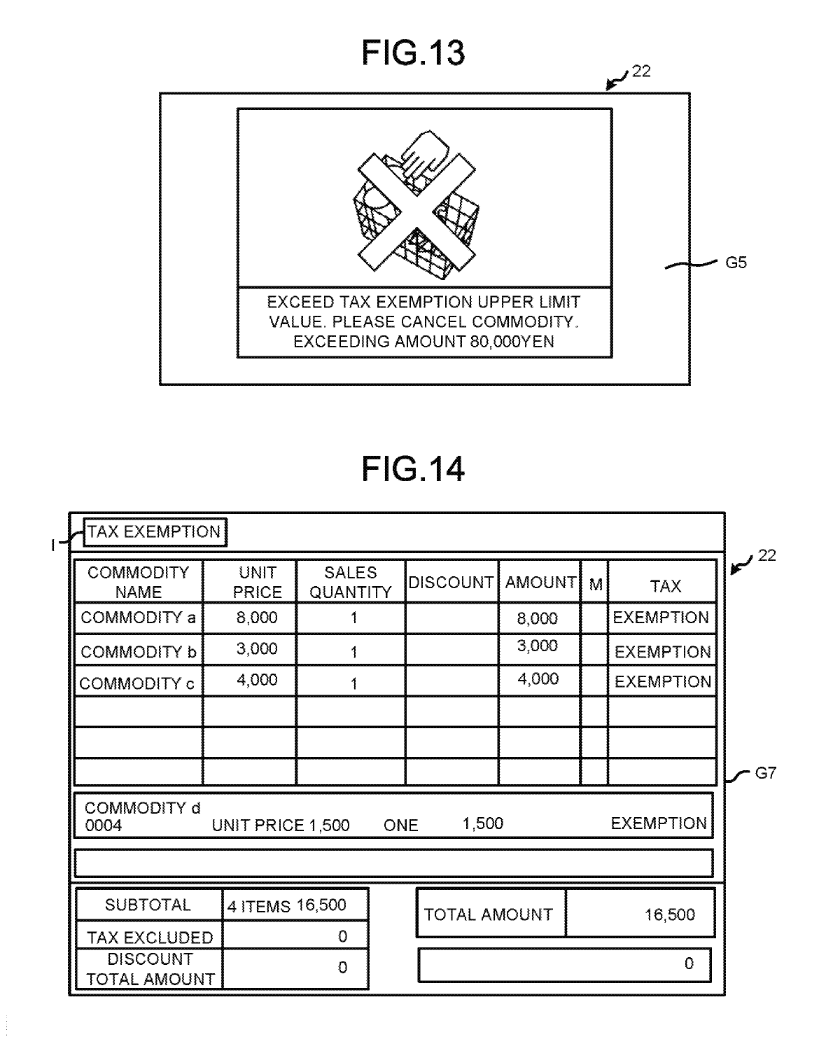

FIG. 13 is a diagram illustrating an example of the error screen. As shown in FIG. 13, at the time of declaring the tax exemption through the operation of the tax exemption declaration key K1, the control section 300 displays a screen indicating “Exceed the tax exemption upper limit value. Please cancel the commodity. Exceeding amount: ______, ______ Yen” as the error screen G5. If the clear key on the keyboard 21 is operated, the control section 300 deletes the error screen.

After such a tax exemption processing is executed, the control section 300 displays the commodity registration screen again (ACT S61). FIG. 14 is a diagram illustrating an example of the commodity registration screen G7 after the redisplay is performed. As shown in FIG. 14, the commodity registration screen G7 after the redisplay is carried out sets the tax amount to “0 Yen” by exempting the tax amount through the tax exemption processing. As shown in FIG. 14, the commodity registration screen G7 after the redisplay is carried out sets the displayed total amount to an amount (amount after tax amount is deducted) after the tax exemption processing is executed. Further, the commodity registration screen G7 after the redisplay is performed displays a character “EXEMPTION” on a tax exemption applied commodity, in other words, the commodity to which the tax exemption processing is being executed.

Next, the control section 300 refers to the commodity master file F1 to determine the presence/absence of a commodity belonging to the dangerous article division in the tax exemption target commodities (ACT S62). If it is determined that there is a commodity belonging to the dangerous article division (Yes in ACT S62), the control section 300 displays a warning screen (not shown) on the display section 22 in a pop-up manner (ACT S63). The control section 300 deletes the warning screen if the clear key on the keyboard 21 is operated. If it is determined, on the other hand, that there is no commodity belonging to the dangerous article division (No in ACT S62), the control section 300 does not execute the processing in ACT S63.

Next, the control section 300 determines whether or not the cash total key is operated (ACT S64). The control section 300 keeps the standby state until the cash total key is operated (No in ACT S64). If it is determined that the cash total key is operated (Yes in ACT S64), the control section 300 executes the settlement processing for calculating the total amount based on the registration amount and the commodity information of the commodity in the transaction (ACT S65). The settlement processing executed in ACT S65 calculates the total amount not including the tax amount of the consumption tax and the like on the sold commodity. This is because that the tax exemption processing is already executed.

The control section 300 sends the commodity information (the transaction number, the transaction date and time, the register number, the commodity code, the unit price, the sales quantity, etc.) of the commodity to which the settlement processing is executed to the server 4 (ACT S66). The server 4 which receives the commodity information stores the received information in the transaction history DB1 (ACT S66). Specifically, the control section 400 of the server 4 stores the transaction number in the transaction number section DB11. The control section 400 stores the transaction date and time in the transaction date and time section DB12. The control section 400 stores the register number of the POS terminal 2 executing the transaction processing in the register number section DB13, and stores the commodity code, the unit price and the sales quantity of the transacted commodity in the commodity information section DB15. The control section 400 stores the flag “1” indicating that the tax exemption processing is executed on the transaction in the flag section DB14 in association with the transaction number of the transaction.

Next, the control section 300 prints the commodity information, the settlement information and the tax exemption amount of the commodity to which the settlement processing is executed on the receipt paper to issue the receipt (ACT S67).

In the processing in ACT S67, the control section 300 prints, for example, one purchase written oath, two purchase record slips and one receipt in a case of the transaction to which the tax exemption processing is executed.

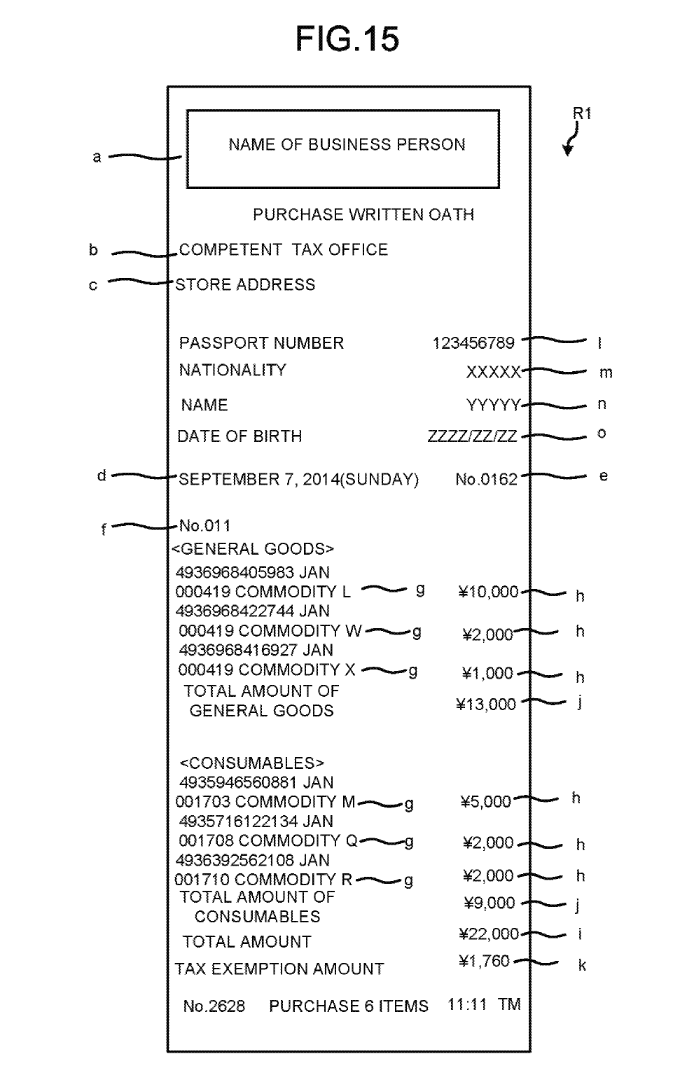

First, the purchase written oath is described. FIG. 15 is a diagram illustrating an example of the purchase written oath R1. The purchase written oath R1 is a document on which the fact of the purchase of the tax exemption item is described. The purchase written oath R1 is attached to a document (purchaser written oath) as a duplicate copy reserved at the store and is presented to the operation company or the business person that runs the duty-free store.

As shown in FIG. 15, the purchase written oath R1 includes a full name (personal name) or company name a of the business person who runs a duty-free store, a competent or district tax office name b, a store address of the duty-free store c, a transaction date d, a transaction number e, a register number f, details of the commodity (commodity name g, quantity and price h for each commodity name), a total amount i of all the items, a total amount j of each of the general goods and consumables and a tax exemption amount k.

The purchase written oath R1 includes a column in which the character string of each item confirmed with the confirmation screen G3 is printed. Specifically, character strings of the following items confirmed with the confirmation screen G3 are printed in the purchase written oath R1.
Passport number . . . l
Nationality of the purchaser . . . m
Full name of the purchaser . . . n
Date of birth of the purchaser . . . o

Further, only the name of the item (character string) deleted by operating the deletion button B1 on the confirmation screen G3 is printed and the item is directly written on the document (purchase written oath). The layout of the purchase written oath R1 is not limited to the example in FIG. 15. For example, a pledge of exporting the commodity after the purchase (in a case of consumables, a pledge of exporting the commodity within 30 days from the purchase date) or a signature column of the purchaser may be printed.

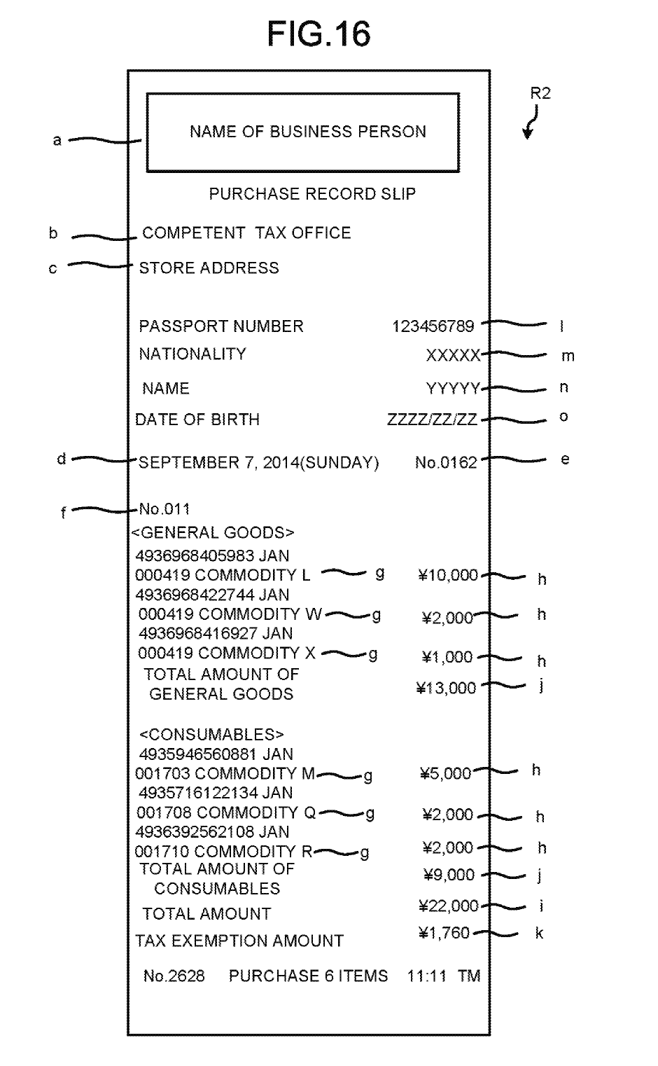

Next, the purchase record slip, i.e., voucher, is described. FIG. 16 is a diagram illustrating an example of the purchase record slip R2. The purchase record slip R2 is a document on which the fact of purchasing the tax exemption article is recorded. Two purchase record slips R2 shown in FIG. 16 are printed for the attachment to the document (purchase record slip) and the copy reserved at a store. The purchase record slip R2 for attachment is adhered to the document (purchase record slip). The document (purchase record slip) is adhered to the passport and is subject to the tally impression.

As shown in FIG. 16, the purchase record slip R2 includes a full name or company name a of the business person who runs a duty-free store, a competent tax office name b, an address of the duty-free store c, a transaction date d, transaction number e, a register number f, details of the commodity or commodities (commodity name g, quantity and price h of each commodity name), a total amount i of all the articles, a total amount j of each of the general goods and consumables and the tax exemption amount k.

The purchase record slip R2 also includes a column in which the character string of each item confirmed on the confirmation screen G3 is printed. Specifically, character strings of the following items confirmed on the confirmation screen G3 are printed on the purchase record slip R2.
Passport number . . . l
Nationality of the purchaser . . . m
Full name of the purchaser . . . n
Date of birth of the purchaser . . . o

Further, only the name of the item (character string) deleted by operating the deletion button B1 on the confirmation screen G3 is printed and the item is directly written on the document (purchase written oath) as similar to the purchase written oath R1. The layout of the purchase record slip R2 is not limited to the example of FIG. 15.

Next, the receipt is described. FIG. 17 is a diagram illustrating an example of the receipt R3. The receipt R3 is delivered to the purchaser after the transaction is performed.

As shown in FIG. 17, the receipt R3 includes a full name or company name a of the business person who runs a duty-free store, a transaction date d, a transaction number e, a register number f, details of the commodity or commodities (commodity name g, quantity and price h of each commodity name), a total amount i of all the articles. As shown in FIG. 17, in a case of the tax exemption applied commodity, a character “exemption” p is printed as a tax printing. In a case of the tax exemption transaction, a tax exemption message “tax exemption transaction is executed.” q is printed on the receipt R3. A barcode W obtained by coding the transaction number e is printed on the receipt R3.

In a case in which the information stored in the transaction history DB1 does not function as a journal, the control section 300 executes a print of the journal corresponding to the purchase record slip R2 and the receipt R3. At this time, the control section 300 prints character strings of all or a part of items confirmed on the confirmation screen G3 on the journal corresponding to the receipt R3.

In this way, the control section 300 reads the prescribed character string from the passport with the passport reader 27 and displays the read character string on the confirmation screen G3 so that the operator can confirm the read character string. The control section 300 prints the character string displayed on the confirmation screen G3 on the document such as the purchase written oath after being confirmed by the operator. In this way, according to the POS terminal 2 of the embodiment, as troublesome procedures such as the filling in the purchaser written oath or purchase record slip every time the commodity is purchased are unnecessary, procedures relating to the tax exemption can be efficiently executed.

The control section 300 automatically executes the tax exemption processing if the commodity amount is greater than the tax exemption reference amount (consumables: 5,000 Yen, general goods: 10,000 Yen) in the each unit of the tax exemption division (consumables, general goods). In this way, according to the POS terminal 2 of the embodiment, the tax exemption registration operation through the determination of the operator is unnecessary, and the sales registration processing of the commodity corresponding to the reform of the tax exemption system can be executed.

If receiving the operation of the commodity name list output key K2, the control section 300 executes a printing processing for outputting the commodity name list (not shown) of the commodities to which the tax exemption is applied. The timing at which the operation of the commodity name list output key K2 is received is not specifically limited. For example, if the operation of the commodity name list output key K2 is received in the process of executing the sales registration processing, the control section 300 executes a list printing processing along with the printing processing described above. If the operation of the commodity name list output key K2 is received at the time the sales registration processing is not executed, the control section 300 executes the list printing processing after the transaction number of the transaction subject to the list printing processing is input.

In the list printing processing of the embodiment, one commodity name list is printed. The commodity name list is a document on which the commodities subject to the tax exemption processing are enumerated. The commodity name list is affixed on a bag or a box for packaging the commodity to which the tax exemption processing is executed.

The commodity name list includes a full name or company name of the business person who runs a duty-free store, the commodity name of the commodity to which the tax exemption processing is carried out, and quantity and price of each commodity name. It is applicable that only consumables among the commodities to which the tax exemption processing is carried out may be printed on the commodity name list. In such a case, determination whether or not the commodity is consumables is executed based on the tax exemption division code in the commodity master file F1 or the tax exemption division file F2. In a case in which the POS terminal 2 is equipped with a label printer, it is applicable that the control section 300 may print the commodity name list with the label printer.

As described above, according to the POS terminal 2, in response to the operation of the commodity name list output key K2, the commodity name list of the commodity to which the tax exemption is applied can be output. In this way, according to the POS terminal 2 of the embodiment, if it is made by law that the commodity name is shown on the package of the commodity to which the tax exemption is applied, the commodity name list is easily issued as described above, and thus the procedures relating to the tax exemption can be efficiently executed.

Returning to the description of FIG. 9, if it is determined that the tax exemption declaration key K1 is not operated in ACT S21 (No in ACT S21), the control section 300 determines whether or not the tax exemption recount key K3 for executing the tax exemption processing on the past transaction is operated (ACT S31). If it is determined that the tax exemption recount key K3 is operated (Yes in ACT S31), the control section 300 executes the tax exemption recount processing serving as the tax-exemption deduction processing (ACT S32).

[Tax Exemption Recount Processing]

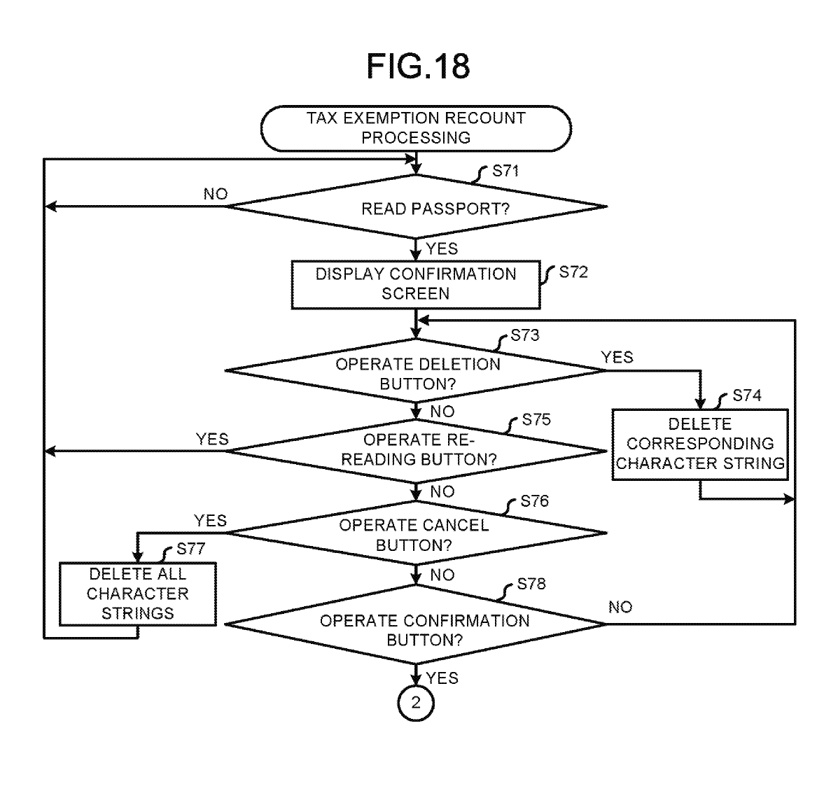

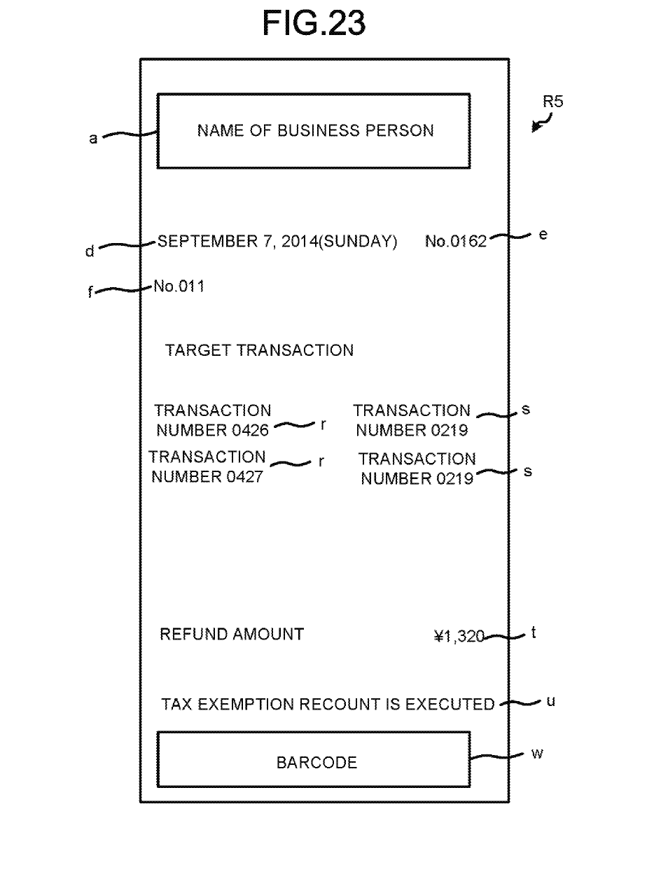

With reference to FIG. 18˜FIG. 23, the tax exemption recount processing (ACT S32) executed when the tax exemption recount key K3 is operated is described.

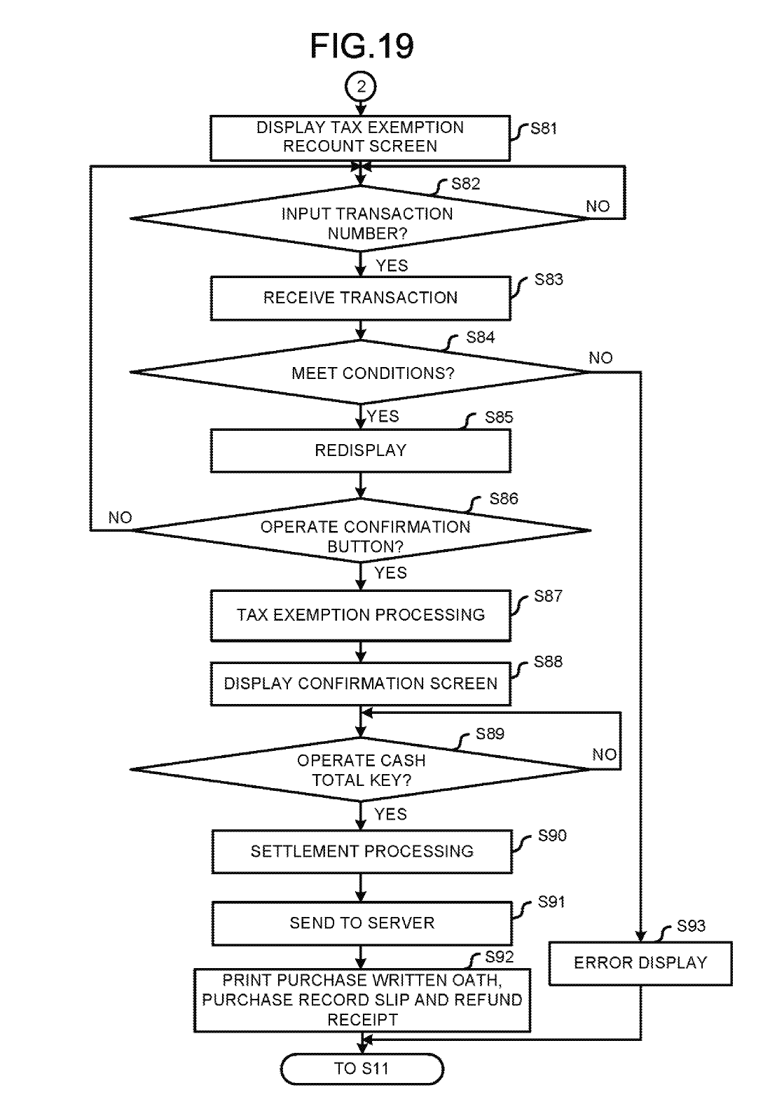

FIG. 18 and FIG. 19 are flowcharts schematically illustrating the flow of the tax exemption recount processing if the tax exemption recount key K3 is operated. First, the control section 300 executes the processing in ACT S71˜ACT S78. The processing in ACT S71˜ACT S78 is the same as that in ACT S51˜ACT S58, and therefore the description thereof is omitted. If the cancel button B4 is operated (Yes in ACT S76), the control section 300 returns to the processing in ACT S71 after deleting all the character strings (data) read from the passport (ACT S77).

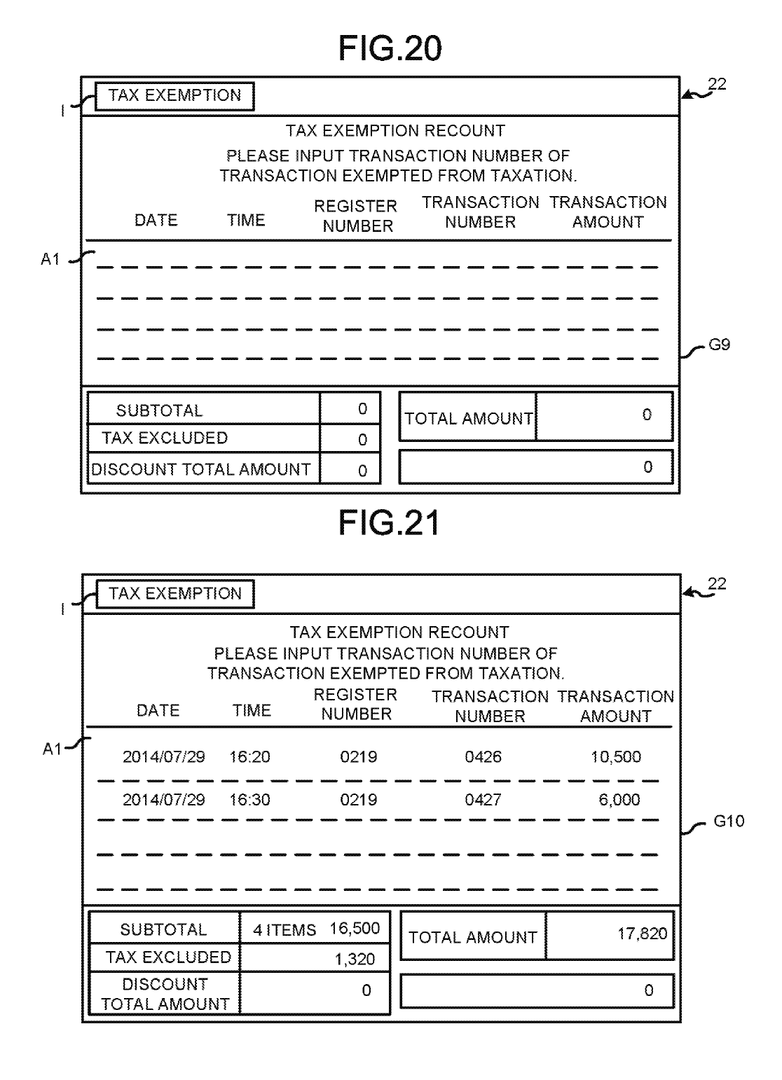

Next, the control section 300 displays the tax exemption recount screen G9 on the display section 22 (ACT S81). FIG. 20 is a diagram illustrating an example of the tax exemption recount screen G9 displayed in the processing in ACT S81. In FIG. 20, the transaction number of the transaction to which the tax exemption processing is executed is not yet input. The tax exemption indicator I indicating the tax exemption processing is displayed on the tax exemption recount screen G9. An area A1 which displays the transaction to which the tax exemption processing is executed is displayed on the tax exemption recount screen G9.

Returning to the description in FIG. 19, the control section 300 reads the barcode printed on the receipt in ACT S15 with the scanner 25 to determine whether or not the transaction number contained in the barcode is input (ACT S82). The control section 300 keeps the standby state until the transaction number is input (No in ACT S82), and if it is determined that the transaction number is input (Yes in ACT S82), the control section 300 inquires the server 4 to receive the past transaction specified with the transaction number from the transaction history DB1 in the server 4 (ACT S83). Then, the control section 300 determines whether or not the received transaction meets the following three (3) conditions (ACT S84).

A first condition is that the transaction read from the transaction history DB1 includes a flag having “0” stored in the flag section thereof. A second condition is that the transaction history includes the commodity to which the tax exemption is applied. A third condition is that the transaction history has the same transaction date as the transaction history read previously. In a case in which all these 3 conditions are met (Yes in ACT S84), the control section 300 (designation module 302) designates a transaction (transaction to which the tax exemption processing is not being executed), specified with the transaction number, on which the tax-exemption deduction processing is performed, and displays the transaction read from the transaction history DB1 on the display section 22 again (ACT S85).

FIG. 21 illustrates the tax exemption recount screen G10 displayed again. In FIG. 21, if the transaction history of the transaction number “0426” is read out, the control section 300 displays the content such that the content is added in the area A1 of the tax exemption recount screen G9 shown in FIG. 20. Then, every time another transaction is read out, the control section 300 displays the content of the transaction by adding it in the area A1. The transaction date and time (date, time), the register number, the transaction number and the tax exemption applicable amount (transaction amount) are displayed in the area A1 as the content of the transaction.

Next, the control section 300 determines whether or not the confirmation button (arranged on the keyboard 21) is operated (ACT S86). If it is determined that the confirmation button is operated (Yes in ACT S86), the control section 300 (tax exemption control module 303) executes the tax-exemption deduction processing for deducting the tax amount from the tax-included total amount on the tax exemption target commodity (ACT S87). The tax-exemption deduction processing executed by the control section 300 in ACT S87 deducts the amount of the tax from the tax-included total amount of the commodity, i.e., the tax exemption target, calculated with the settlement processing in ACT S14 for the past transaction. In detail, a taxation processing is executed on the tax exemption target commodity through the settlement processing in the past transaction in ACT S14. Thus, the control section 300 executes a tax exemption processing in which the tax amount imposed in the processing in ACT 14 is deducted from the tax-included total amount on the tax-exemption target commodity in ACT S87. Then, the control section 300 displays a tax exemption recount screen G11 confirmed after the tax exemption deduction processing is carried out (ACT S88). Further, if it is determined that the confirmation button is not operated (No in ACT S86), the control section 300 returns to the processing in ACT S82.

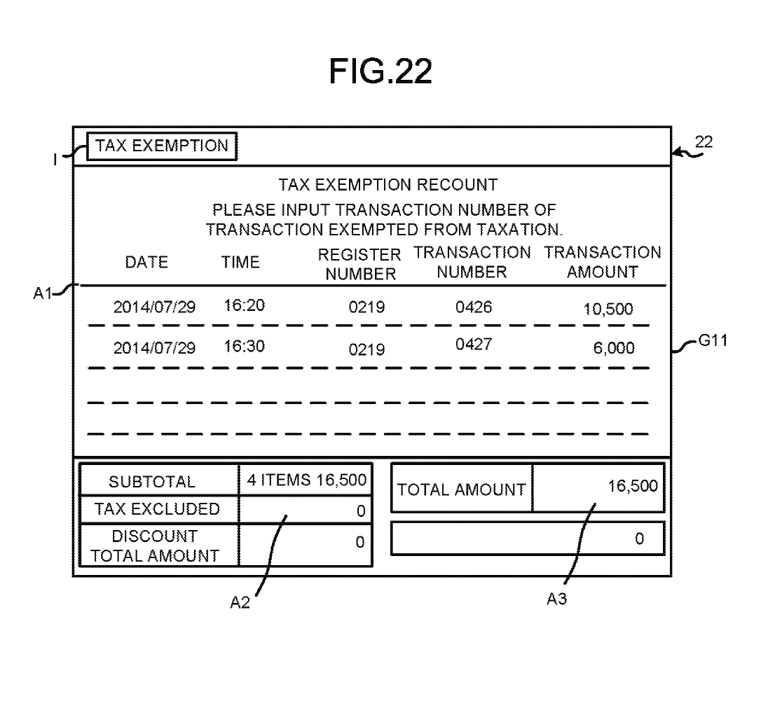

FIG. 22 is an example of a confirmed tax exemption recount screen G11. In FIG. 22, a tax amount column A2 displays 0 (zero) Yen as the result of execution of the tax exemption processing. A tax-excluded total amount is displayed in the total amount column A3.

Next, the control section 300 determines whether or not the cash total key is operated (ACT S89). The control section 300 keeps the standby state until the cash total key is operated (No in ACT S89). If it is determined that the cash total key is operated (Yes in ACT S89), the control section 300 executes the settlement processing (ACT S90). In the settlement processing executed in ACT S90, the total amount not including the tax amount, which is obtained by deducting the tax amount (consumption tax and the like) from the initial total amount, is calculated because of the tax exemption recount processing being executed. Then, the control section 300 sends the transaction number of the transaction to which the tax exemption recount processing is executed to the server 4 (ACT S91). The server 4 receiving the information rewrites the flag, corresponding to the transaction number, which is stored in the flag section DB14, from “0” to “1”.

Next, the control section 300 (voucher issuing module 304) prints one purchase written oath, two purchase record documents, one refund receipt through the printer 23 to issue them (ACT S92). In ACT S84, if it is determined that the transaction specified with the input transaction number does not meet one or more conditions among the 3 conditions described above (No in ACT S84), the control section 300 displays an error message indicating that the tax exemption processing cannot be executed on the display section 22 (ACT S93).

Further, it is possible that the transaction displayed on the tax exemption recount screen is excluded (deleted) from the processing targets by an operation through the keyboard 21 or the touch panel. Through selecting the transaction displayed on the tax exemption recount screen, it is applicable that the commodities, i.e., tax exemption targets, contained in the transaction can be displayed in a list format.

The refund receipt is described. FIG. 23 is a diagram illustrating an example of a refund receipt R5. The refund receipt R5 is a document on which the transaction subject to the tax exemption recount processing and an amount (tax exemption amount) which is refunded as the result of execution of the tax exemption recount processing are described. The refund receipt R5 is delivered to the customer (nonresident).

As shown in FIG. 23, the refund receipt R5 includes a full name or company name a of the business person who runs a duty-free store, and a transaction date d, a transaction number e and a register number f on which the tax exemption recount processing is executed. The refund receipt R5 also includes a transaction number r, a register number s, and a refund amount t of each transaction subject to the tax exemption recount processing. As shown in FIG. 20, a message “tax exemption recount is executed.” u indicating that the tax exemption recount is executed is printed on the refund receipt R5. Further, a barcode w, in which the number e of the transaction to which the tax exemption recount processing is executed is coded, is printed on the refund receipt R5.

As described above, according to the embodiment, for one or more transactions designated as the processing target after the transaction processing is carried out, the tax exemption processing to the tax exemption target commodity contained in the transaction can be executed with such a simple operation (sales recount processing) described above. Therefore, even if the procedures of the tax exemption are executed after the commodities are sold, the tax exemption processing can be executed without canceling the transaction of the tax exemption target commodities to which the taxation processing is already executed.

Returning to the description in FIG. 9, in ACT S31, if it is determined that the tax exemption recount key K3 is not operated (No in ACT S31), the control section 300 determines whether or not the sales data cancellation key K4 is operated (ACT S41). If it is determined that the sales data cancellation key K4 is operated (Yes in ACT S41), the control section 300 sequentially determines whether or not the tax exemption recount key K3 is operated (ACT S42). If it is determined that the tax exemption recount key K3 is operated (Yes in ACT S42), the control section 300 executes a tax exemption recount cancellation processing (ACT S43).

In the series of the transactions, the tax exemption recount processing can be executed only once. Thus, if there is an incorrect commodity to which the tax exemption recount is already executed, or if the tax exemption recount is required to be executed again as there is a commodity to which a new tax exemption processing is required to be executed, it is necessary to execute the tax exemption processing again after the tax exemption recount cancellation processing for canceling the tax exemption recount processing previously executed is executed.

[Tax Exemption Recount Cancellation Processing]

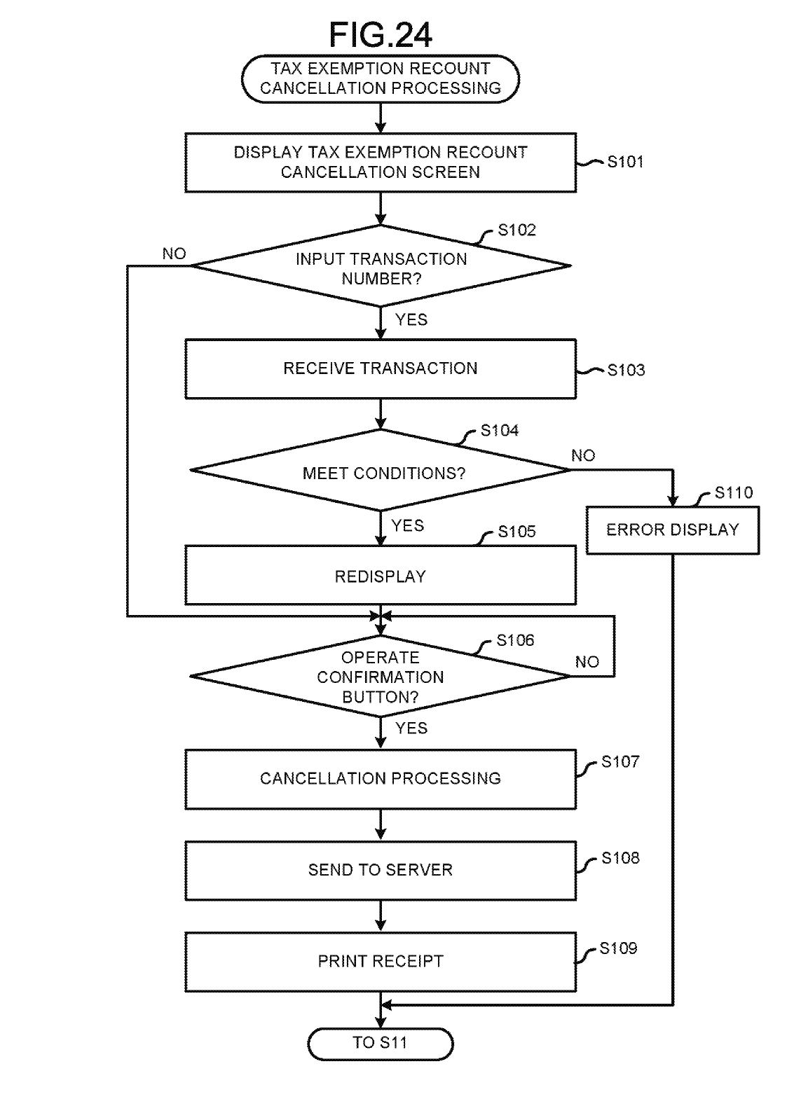

Hereinafter, with reference to FIG. 24-FIG. 27, the tax exemption recount cancellation processing (ACT S43) executed when the sales data cancellation key K4 and the tax exemption recount key K3 are sequentially operated is described.

In FIG. 24, if the sales data cancellation key K4 and the tax exemption recount key K3 are sequentially operated, the control section 300 displays the tax exemption recount cancellation screen G12 for executing the cancel of the tax exemption recount on the display section 22 (ACT S101).

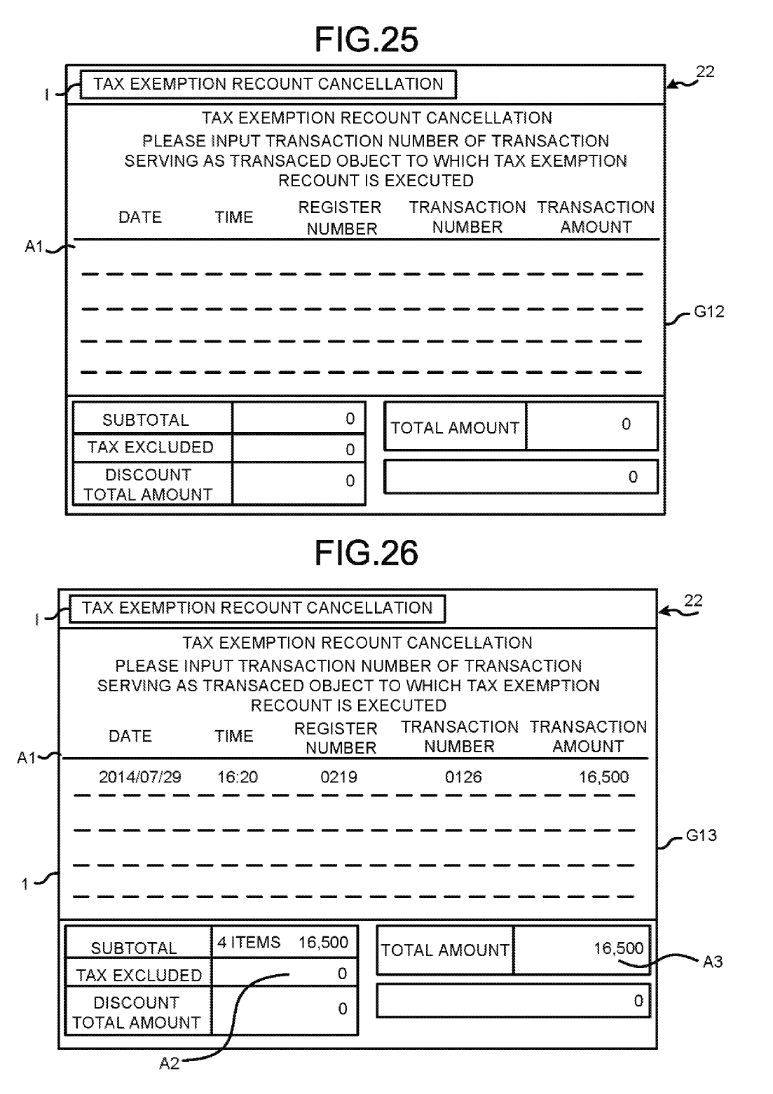

FIG. 25 illustrates an example of a tax exemption recount cancellation screen G12 displayed in the processing in ACT S101. In FIG. 25, the number of the transaction to which the tax exemption processing is executed is not yet input. The tax exemption recount cancel indicator I for canceling the tax exemption recount is displayed on the tax exemption recount cancellation screen G12. Further, an area A1 in which the transaction to which the tax exemption cancellation processing is executed is displayed on the tax exemption recount cancellation screen G12.

Return to the description in FIG. 24. The control section 300 reads the barcode W printed on the refund receipt R5 in the processing in ACT S92 with the scanner 25 to determine whether or not the transaction number contained in the barcode W is input (ACT S102). If it is determined that the transaction number is input (Yes in ACT S102), the control section 300 inquires the server 4 to receive the transaction history, specified with the transaction number, to which the tax exemption recount is executed, in the transaction history DB1 from the server 4 (ACT S103).

Next, the control section 300 determines whether or not the conditions for executing the tax exemption recount cancellation processing are met (ACT S104) based on the received transaction history. The conditions include the following 3 items: (1) the transaction is being stored in the transaction history DB1, (2) the transaction is processed with the tax exemption recount processing, and (3) the transactions subject to the cancellation processing have the same business day with one the other. If all these 3 items are met, the control section 300 determines that the transaction meets the requirements for executing the tax exemption recount cancellation processing in ACT S104.

In ACT S104, if it is determined that the conditions are met (Yes in ACT S104), the control section 300 displays the tax exemption recount cancellation screen G13 containing the transaction history specified with the input transaction number again (ACT S105). FIG. 26 illustrates an example of a tax exemption recount cancellation screen G13 that is displayed again. In FIG. 26, the transaction history, specified with the transaction number “0162”, the tax exemption recount to which is canceled is displayed in the area A1. In this state, the tax amount displayed in a tax amount column A2 is 0 (zero) Yen, and the total amount displayed in a total amount column A3 contains no tax amount. Further, in ACT S104, if it is determined that the conditions are not met (No in ACT S104), an error message indicating that the conditions are not met is displayed on the display section 22 (ACT S110).

Next, the control section 300 determines whether or not the confirmation button arranged on the keyboard 21 is operated (ACT S106). The control section 300 keeps the standby state until the confirmation button is operated (No in ACT S106). If it is determined that the confirmation button is operated (Yes in ACT S106), the control section 300 (cancellation module 305) executes the cancellation processing on the transaction specified with the transaction number (ACT S107). The cancellation processing refers to a processing of creating the information for deleting the transaction history of the transaction, specified with the input transaction number, which is stored in the transaction history DB1. Then, the control section 300 sends the created information for deleting the transaction history to the server 4 (ACT S108). The control section 400 of the server 4 that receives the information deletes the transaction history stored in the transaction history DB. In this way, the transaction is not existed in the transaction history DB. Further, in the server 4, if the transaction history DB1 also acts as the journal data, the canceled transaction history is not actually deleted from the transaction history DB1 but is added with information indicating that the transaction is canceled in correspondence with the transaction number. With the information added, the transaction history specified with the transaction number is regarded to be deleted from the transaction history DB1.

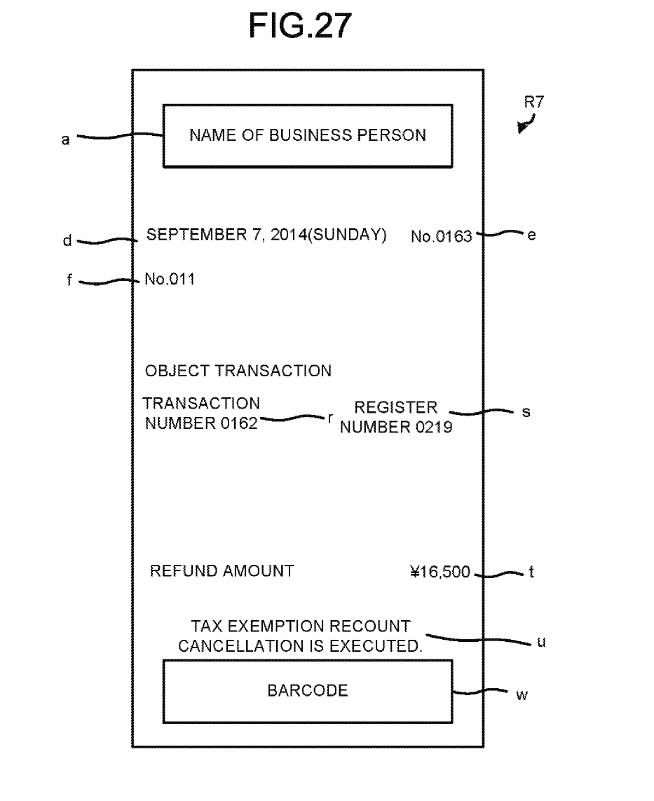

The control section 300 prints a cancellation receipt indicating the execution of the tax exemption recount cancellation processing with the printer 23 to issue it (ACT S109). FIG. 27 illustrates an example of the cancellation receipt issued in ACT S109. In FIG. 27, the cancellation receipt R7 includes a full name or company name a of the business person who runs a duty-free store, and a transaction date d, a transaction number e and a register number f on which the tax exemption recount processing is executed. The cancellation receipt R7 also includes a transaction number r and a register number s of each transaction to which the tax exemption recount processing is executed, and a refund amount t resulting from the execution of the cancellation processing. A message “cancel of tax exemption recount is executed.” u indicating that the tax exemption recount processing is once executed is printed on the cancellation receipt R7. Further, a barcode w, in which the number e of the transaction to which the tax exemption recount cancellation processing is executed is coded, is printed on the cancellation receipt R7.

Return to the description in FIG. 9. If it is determined that the tax exemption recount key K3 is not operated in ACT S42 (No in ACT S42), the control section 300 executes the cancellation processing on, for example, the transaction to which the settlement processing is executed in ACT S14 and the transaction to which the tax exemption processing is executed in ACT S22 (ACT S44). The cancellation processing in ACT S44 is equivalent to that in ACT S107. Further, after the processing in ACT S12, the processing in ACT S16, the processing in ACT S22, the processing in ACT S32, the processing in ACT S43 and the processing in ACT S44 are carried out, the control section 300 returns to the processing in ACT S11. If it is determined that the sales data cancellation key K4 is not operated in the processing in ACT S41 (No in ACT S41), the control section 300 returns to the processing in ACT S11.

In this way, according to the embodiment, for one or more transactions designated as the processing target, the tax exemption recount cancellation processing can be executed without canceling the transaction to which the tax exemption recount processing is executed.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment described above, the information kept on the passport is read as the character string with the optical character recognition function of the passport reader 27; however, the reading method is not limited to this. Specifically, in a case in which a recording medium such as an IC tag is embedded in the passport, it is applicable that information corresponding to recorded items is read from the recording medium with the use of an RFID reader as the passport reader 27.

In the embodiment described above, a barcode printed on the receipt is read at the time of inputting the transaction number; however, it is not limited to this. For example, the operator may input the transaction number printed on the receipt through the keyboard 21.

In the embodiment described above, the transaction history DB1 is arranged in the server 4; however, the structure is not limited to this, for example, the transaction history DB1 may be arranged in the POS terminal 2.

In the embodiment described above, the commodity is described as an example of the sales item; however, it is not limited to this. An intangible sales item other than the commodity, e.g., service, may be applied.

Further, in the embodiment described above, the POS terminal 2 is described as an example of the information processing apparatus; however, it is not limited to this. A personal computer and the like arranged on a checkout counter may be used as the information processing apparatus.

What is claimed is:

1. An information processing apparatus, comprising:
a tax exemption processing module configured to execute a tax exemption processing for exempting payment of tax on a sales item which is exempted from the taxation;
a designation module configured to designate a transaction to which the tax exemption processing is not executed; and
a tax exemption control module configured to carry out a tax-exemption deduction processing for deducting a tax amount from a tax-included total amount of the sales item which is exempted from the taxation in the transaction designated by the designation module.

2. The information processing apparatus according to claim 1, wherein the designation module designates a transaction to which the tax exemption processing is not executed based on a tax exemption information, stored in a memory section for each transaction, which indicates whether or not the tax exemption processing by the tax exemption processing module is executed.

3. The information processing apparatus according to claim 1, further comprising a voucher issuing module configured to print a voucher containing information of the sales item to which the tax-exemption deduction processing is executed by the tax control module to issue it.

4. The information processing apparatus according to claim 2, further comprising a voucher issuing module configured to print a voucher containing information of the sales item to which the tax-exemption deduction processing is executed by the tax control module to issue it.

5. The information processing apparatus according to claim 1, further comprising a cancellation module configured to cancel the tax-exemption deduction processing executed by the tax exemption control module.

6. The information processing apparatus according to claim 1, wherein the tax exemption control module prohibits the tax-exemption deduction processing by the tax exemption control module and notifies that the tax-exemption deduction processing cannot be executed if the tax-excluded total amount of the sales item contained in the transaction designated by the designation module is greater than an amount available to applying the tax exemption.

7. The information processing apparatus according to claim 1, wherein the tax exemption control module executes the tax-exemption deduction processing if the sales item which is exempted from the taxation is contained in the transaction designated by the designation module.

8. A method for deducting a tax amount, including:
executing a tax exemption processing for exempting payment of tax levied on a sales item which is exempted from the taxation;
designating a transaction to which the tax exemption processing is not executed; and
carrying out a tax-exemption deduction processing for deducting a tax amount from a tax-included total amount of the sales item which is exempted from the taxation in the transaction designated by the designation module.
